(19) United States
(12) Patent Application Publication
(10) Pub. No.: US 2022/0364859 A1
(43) Pub. Date: Nov. 17, 2022

(54) ELECTRONIC CONDUIT-BENDING INDICATOR, LEVEL, AND ENVIRONMENTAL DATA DISPLAY

(71) Applicant: Baran Grejtak Galocy, Palm Desert, CA (US)

(72) Inventor: Baran Grejtak Galocy, Palm Desert, CA (US)

(21) Appl. No.: 17/868,413

(22) Filed: Jul. 19, 2022

Related U.S. Application Data
(63) Continuation-in-part of application No. 17/064,457, filed on Oct. 6, 2020, now abandoned.

(51) Int. Cl. G01C 9/06

(52) U.S. Cl. CPC G01C 9/06

(57) ABSTRACT

An Electronic Conduit Bending Indicator, Level, and Environmental Data Display is disclosed. It easily inserts directly into the opening of conduit or pipe bender, allowing the user to have the display within easy viewing distance. The conduit bending indicator displays actual and relative angles from the horizontal plane on the Y-axis and functions as a spirit level on the X-axis. It has a 4-way level for measuring the X and Y axes with relative and actual angular display and data-hold, and a protractor function allows relative angular measurements when rotated horizontally. The invention also displays the dry-bulb, wet-bulb, and dew-point temperatures, OSHA heat-index (sunny and shady), enthalpy (sensible, latent, and Qs/Qt), saturated and actual vapor pressure, relative humidity, absolute humidity, humidity ratio, vapor pressure, cubic feet per pound of dry air, atmospheric pressure, altitude, vapor deficit, vapor density, and partial, actual, and dry air densities. This data may be read from the environment or calculated.

### CROSS-REFERENCE TO RELATED APPLICATIONS

The present application claims priority as a Continuation-In-Part to U.S. Non-Provisional patent application Ser. No. 17/064,457 filed Oct. 6, 2021, entitled “ELECTRONIC CONDUIT BENDER INDICATOR AND RELATIVE LEVEL,” which is hereby incorporated by reference in its entirety.

### TECHNICAL FIELD

Embodiments of the invention relate to electronic conduit-bending indicators, levels, and environmental data displays.

### BACKGROUND

Various digital and analog angle gauges are currently available for measuring the tilt or inclination of an object or a work surface. Inclinometer-type angle gauges typically feature a generally rectilinear configuration. A digital display screen and operating buttons are mounted on a vertical front face of the device. At least one side surface of the inclinometer functions as a reference surface for engaging the work surface or object to be measured for inclination.

The foregoing angle gauges exhibit one or more shortcomings when using them to determine the angle of a piece of conduit or pipe when bending. The viewing screen (if electronic) is invariably oriented perpendicular to the ground and can be difficult to view and read clearly from above and/or peripherally. Also, positioning the push buttons that operate the gauge (especially the FUNCTION button) anywhere but on the front face of the gauge can be problematic, as the operator cannot easily see them.

A typical conduit bender comprises two parts: a handle and a former, or head. The handle is screwed into the former which has an arcuate shoe at the bottom with a laterally concave groove in the bottom of the shoe into which the conduit fits with a small clearance. The former further comprises a hook, foot-press, and angle markings. The hook grasps the conduit received in the groove and the conduit is bent by exerting a force on the handle to roll the shoe along the conduit, with the conduit between the floor and the former. The foot-press may be used for additional leverage and stability.

The arcuate bend imparted to the conduit or tubing as the tool head is rolled has a radius substantially equal to that of the are to which the shoe is curved along its length. The bend angle produced in the conduit is dependent upon the distance through which the handle is rolled rearward towards the user during the bending operation. The bend angle is the angle between the straight sections of conduit that are at opposite ends of the curve imparted to the conduit by means of the conduit bending tool.

Before the invention of the Electronic Conduit Bending Indicator, Level, and Environmental Data Display, there were two methods to properly estimate the bend angle of the conduit. The first is to repeatedly look at the former to read and interpret the embossed angle marks. The second is to attach a clamp-on bubble level to the conduit that is being bent and repeated reference this bubble level to estimate the angle. The invention solves the bend-angle issue by inserting directly into the handle of the conduit bender in-line with the sight of the operator. When the operator engages a length of conduit with the holding clamp of the former on the conduit bender, s/he simply resets the indicator, referencing this as the new 0°, or “flat” angle. As the conduit is bent, the device displays the actual conduit bend angle at eye level. The inverted rear OLED display allows visual continuity of the output data as the bend angle increases. The device generally engages all conduit benders by means of a half-tapered base which allow for a variety of handle diameters.

Various means and methods have been developed to provide an accurate determination of the bend angle while bending conduit. Several methods such as disclosed in U.S. Pat. No. 5,669,258, Luebke, involve attaching a tube bend angle indicator to the tool handle. As the handle is moved to make the bend in the conduit, a pointer or other indicator (e.g., a bubble in a bubble level indicator) moves relative to horizontal to indicate the bend angle. This type of bend angle indicator provides a high degree of accuracy. However, such indicators are not integral parts of the bender and are not always available at a job site.

In U.S. Pat. No. 4,442,695, Gardner and U.S. Pat. No. 4,009,603, Linguist, markings on the tool head provide a sight line for determining the bend angle by the user. When markings on the tool head were properly aligned during the bend operation, the conduit was substantially bent to the desired bend angle. This type of bend angle indicator can be cast into the head and is less susceptible to damage in a harsh environment. The downside is that the markings are not in the line of vision of the operator of the conduit bender, and they offer only an approximation in 10° increments.

The invention disclosed in U.S. Pat. No. 4,442,695, Gardner, represented a significant improvement over the arrangement in U.S. Pat. No. 4,009,602, Linquist, in that a more accurate bend angle was obtainable on the job site. Both of these prior art inventions, however, were limited in the number of predetermined bend angles that could be displayed on the bender head. In the Linquist invention, available space for marking angles is limited to a small arc on the front end of the shoe.

The Gardner invention solved this problem by providing angle indicators along the length of the shoe, but the tipper rib segment of the indicator is crowded on the handle socket, converging on a single apex, thereby limiting additional angle indicator ribs. The limited number of predetermined bend angles requires the user to estimate bend angles that are not indicated on the tool. Therefore, it is desirable to provide a bending tool with the capability of indicating any possible bend angle to the degree, thus reducing the amount of estimating required.

In U.S. Pat. No. 5,927,141 A, Walsten introduces an improvement wherein an outer surface of the former portion of a conduit bender is shaped so as to project from a lateral side of (a) socket in a plane which is perpendicular to (the) handle axis to define a sighting point at (the) lateral side which is visible by a user's eye from the same lateral side of (the) handle, and a plurality of bead projections that are spaced along the length of (the) shoe portion on the same lateral side of (the) head of (the) sighting point so that each of (the) bead projections can be visually aligned with (the) sighting point along a line of sight by a user operating (the) handle, wherein (the) socket is formed to define a collar around its upper end, and (the) collar projects to define (the) sighting point at (the) lateral side of (the) socket. This invention still presents the downside of requiring the operator to estimate angles between the marked points.

All of these patents rely on mechanical means of angular interpretation and require the operator to make estimates for angles between those indicated.

More recently, a number of electronic levels and angle-measuring devices have been introduced to the market. None, to date, are easily used with a standard conduit bender.

Patent US20110197651A1, by Barry Douglas Wixey, Shi Jian and Li Guang Jin, is representative of these iterations of electronic levels and relative angle devices presently on the market. This device, one imagines, might attach magnetically to the side of a conduit bender handle and, due to its design, render the output difficult to read and the device itself quite susceptible to accidental removal and damage.

There are many examples of digital electronics being married with conventional tools of many different trades. With this invention, the problem of precise pipe or conduit bending is solved, as well as any need for a relative level. These issues are addressed separately below.

Hand-operated conduit benders are universal. They comprise a handle and a former, which further comprises a holding clamp, foot-press, and angler markings. The former rests on the floor surface with the handle upright. The operator engages the holding clamp with a length of conduit that is lying on the floor. When the bender is engaged with the conduit, the handle is no longer vertical, due to the curved nature of the former. The device, as well, is no longer vertical because it is inserted into the conduit bender handle. The operator engages the reset button which now displays a zero degree relative angle. As the operator bends the conduit by pulling on the handle while rolling the conduit bender towards him or herself, the display shows the exact bend angle. As the operator bends past a predetermined angle, the inverted rear display activates for ease of viewing.

This invention may also be used as a dual-axes Relative Level. In this mode of operation, the Relative Level is placed onto a surface and the X and/or Y angles of this surface can be referenced as the new zero-angle. One can now place the Relative Level upon any other surface angle and the Relative Level will display the difference between the two angles. This feature is useful when setting items at specific angles onto slopped roofs, especially solar panels, vents, and HVAC mounts.

This invention may also be used as an electronic psychrometric sensor as it contains an atmospheric sensor means to determine the temperature, relative humidity, and atmospheric pressure of the environment and, through software, calculate additional data points.

Finally, this invention may be used as a psychrometric calculator by allowing the operator to override the atmospheric sensor means with manually entered data.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The invention provides a precise means of determining the bend angle of a piece of conduit or pipe electronically. The operator need not rely on mechanical indicators to achieve a precise bend angle. The primary embodiment is housed in a plastic case with a base inserted into the throat of a handheld conduit bender, such that the display is directed towards the operator's face. The base is tapered near the top allowing any standard-sized conduit bender to be employed. After engaging the conduit with the conduit bender's hook, the operator presses the “Reset” switch, thereby resetting this angle-of-engagement as the new zero-degree position. As the operator bends the conduit, the electronic conduit angle indicator accurately displays the exact bend angle of the conduit on two OLED screens. When the desired angle is reached, the operator disengages the bender from the conduit leaving a much more accurate bend angle than could ever be achieved by mechanical means. A brief press of the function switch will again reset the bender to a relative-zero position. A long press returns to the main menu.

A general object of the invention is to provide an accurate versatile electronic conduit bending indicator tool that requires no estimating by the user. This is accomplished by providing dual digital displays that remain within easy sight of the user.

Another object of the invention is to provide an electronic conduit angle bending indicator tool that is easily used on a multiplicity of conduit benders, pipe benders, and rebar benders without the need for re-calibration. This is achieved by the tapered base.

Another object of the invention is for use as a general level indicator for construction purposes. The invention measures both true and relative angles along the X and Y axis and will adhere to any ferrous surface to provide an accurate angle indication. The device may also be attached to a steel plate base when measuring the angle of non-ferrous items. The relative function is especially useful on rooftops. A brief press calls up the relative feature while a long press holds the data. The inverted rear OLED display is especially useful when suspending the device from above, as the data displayed will appear right-side-up.

Another object of the invention is use as a protractor, or relative compass. This allows the user to measure angular differences on the horizontal plane by rotating the device in the freestanding position referencing the protractor indicator pointer. Any starting point may be reset to zero degrees. Rotating left yields negative relative angles while rotating towards the right yields positive relative angles.

Yet another object of the invention is use as an electronic HVAC psychrometric chart due to its internal atmospheric sensor chip. This allows display of the dry-bulb, wet-bulb, and dew-point temperatures, OSHA heat-index, enthalpy (sensible and latent), saturated and actual vapor pressure, relative humidity, absolute humidity, humidity ratio, vapor pressure, cubic feet per pound of dry air, atmospheric pressure, altitude, vapor deficit, vapor density, and partial, actual, and dry air densities. These functions give the device a crossover appeal between HVAC, electrical, and welding trades.

These and other advantages and objects of the invention will become evident from the following detailed description and the drawings.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a front elevation view of the electronic conduit bending indicator, level, and environmental data display of the device, according to some embodiments;

FIG. 2 illustrates a right-side elevation view of the electronic conduit bending indicator, level, and environmental data display of the device, according to some embodiments;

FIG. 3 illustrates a left-side elevation view of the electronic conduit bending indicator, level, and environmental data display of the device, according to some embodiments;

FIG. 4 illustrates a rear elevation view of the device, according to some embodiments;

FIG. 5 illustrates a top plan view of the device display, according to some embodiments;

FIG. 6 illustrates a bottom plan view of the device, according to some embodiments;

FIG. 7 illustrates a wiring pictorial showing how the 4-conductor harness connects the OLED displays, MPU6050, Seeeduino XIAO, and the BME280 using I2C communications protocol, and the connection for the 18650 battery to the TP4056 USB battery charging module and power switch, according to some embodiments;

FIG. 8 illustrates a side elevation view of a typical conduit bender holding the device while engaging a piece of conduit that has been bent into a 90-degree angle, according to some embodiments;

FIG. 9A illustrates a schematic of the device on a negative 7-degree incline along the X-axis relative to the operator, according to some embodiments;

FIG. 9B illustrates a schematic of the device on a negative 15-degree incline along the X-axis relative to the operator, according to some embodiments;

FIG. 9C illustrates a schematic of the device on a positive 15-degree incline along the X-axis relative to the operator, according to some embodiments;

FIG. 9D illustrates a schematic of the device on a positive 7-degree incline along the X-axis relative to the operator, according to some embodiments;

FIG. 9E illustrates a schematic of the device being used as a 4-way level, measuring two angles simultaneously, according to some embodiments;

FIG. 9F illustrates a schematic of the device being used as a conduit bending angle indicator with the dual displays showing the output before and after resetting, according to some embodiments;

FIG. 9G illustrates a schematic of the device being used as a conduit bending angle indicator that has been rolled back towards the operator, so the device is vertical, but the angle of the conduit bend is 30 degrees because the device zeroed itself out at negative 30 degrees when the device of FIG. 9F began engaging the conduit; according to some embodiments;

FIG. 9H illustrates the device inverted by suspending it from above, magnetically or mechanically. The inverted rear-facing OLED display shows data properly oriented to the viewer.

FIG. 10 illustrates a schematic of the device designed to be built entirely inside the handle of a typical conduit bender, according to some embodiments;

FIG. 11 illustrates a schematic of the device with Power Switch and Function Switch being inserted to the depth of its taper into a large conduit bender handle, according to some embodiments;

FIG. 12 illustrates a perspective view of a typical conduit bender showing the handle, former, and hook without engaging conduit, according to some embodiments;

FIG. 13A illustrates a top plan view of the face of the device displaying the Protractor Feature when reset to zero degrees, according to some embodiments;

FIG. 13B illustrates a top plan view of the face of the device displaying the Protractor Feature when rotated negative forty degrees (to the left), according to some embodiments;

FIG. 13C illustrates a top plan view of the face of the device displaying the Protractor Feature when rotated positive twenty degrees (to the right), according to some embodiments; and

FIG. 14 illustrates a block diagram of the hierarchy of the menu items, according to some embodiments.

### DETAILED DESCRIPTION

The specific details of the single embodiment or variety of embodiments described herein are set forth in this application. Any specific details of the embodiments are used for demonstration purposes only, and no unnecessary limitation or inferences are to be understood therefrom.

Before describing in detail exemplary embodiments, it is noted that the embodiments reside primarily in combinations of components related to the system. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### Item List

1. Gauge Body comprising 3D-printed PETG filament, injection-molded PVC, and/or other materials and methods necessary to create a durable housing to contain the electronics

2. Electronic Conduit-Bending Indicator, Level, and Environmental Data Display, also referred to as “the device” comprising a Gauge Body and Necessary Electronic Components

3. Typical Conduit Bender

4. Handle of a Typical Conduit Bender

5. Former of a Typical Conduit Bender

6. Hook Portion of Former of Typical Conduit Bender for Grasping Conduit

7 Inclination Angie

8. Power Switch

9. Flat Reference Surface for free-standing measurements

10. Five-Position Function Switch

11. Protractor Indicating Pointer

12. Ferrous Metal Beam

14. Conduit Bent Into a 90° Shape

15. Port for the Atmospheric Sensor Module

16. Faceplate

18. Tapered Cylindrical Reference Surface to allow the device to fit various sizes of conduit benders

20. Recessed N-52 Neodymium Magnet for Freestanding use on Ferrous Metals

22. Dual Axes angular display

24. Absolute Angle Indicator

26. Relative or Bend Angle Indicator

28. 3-Digit Angle Indicator

30. Graphic Representation of Current Conduit Bend Angle

32. 2-Digit Bubble Level Display for −9° Through 9°

34. Organic Light-Emitting Diode Display (OLED—32×128×I2C)

35. Inverted Organic Light-Emitting Diode Display (OLED—32×128—I2C)

36. 18650 LiPo Rechargeable Battery

38. MPU6050 Angular Sensor and Accelerometer Chip

40. Seeeduino XIAO Microprocessor

42. BME280 Atmospheric Sensor

44. TP4056 LiPo Battery Charging Module with Micro USB Power Connector

45. USB Charging Port to Access the USB Power Connector

46. Attachment Screws, M3X.5 Thread, 12 mm Length

48. Wiring Harness, 4-Conductor, 22 gauge, PVC-Coated, Color-Coded Solid Wires

50. Navigational Menu of all Functions

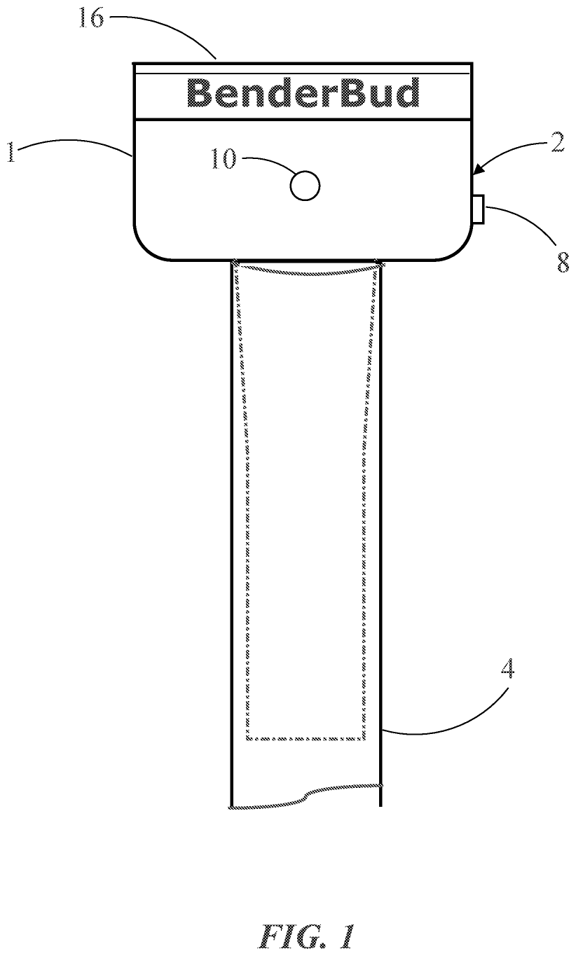

FIG. 1 shows the front view of an Electronic Conduit Bending Indicator, Level, and Environmental Data Display 2 hereafter referred to as “device” or “the device” for simplicity. This view shows the power switch 8 in profile and the five-position function switch 10 in the center of the gauge body 1 while seated in the open handle end of a standard one-inch conduit bender 4.

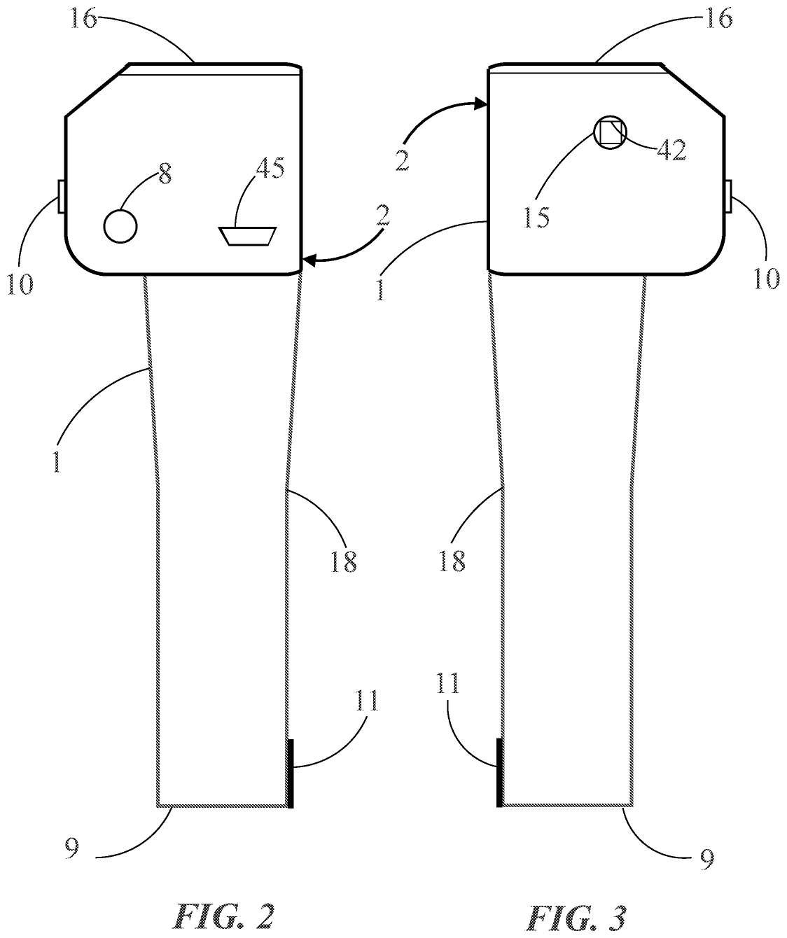

FIG. 2 is a right-side view of the device 2. The USB charge port 45 and power switch 8 are seen face on while the five-position function switch 10 is seen from its profile. The protractor indicator pointer 11 is shown at the right bottom of the figure in profile. The taper 18 can be clearly seen, rising from the middle of the gauge body 1 base and expanding several millimeters in diameter upon reaching the gauge body 1 head.

FIG. 3 is a left-side view of the device 2. The BME280 Atmospheric Sensor 42 may be seen behind the ventilation port 15 while the five-position function switch 10 is seen from its profile. The protractor indicator pointer 11 is shown at the left bottom of the figure in profile. The taper 18 can be clearly seen, rising from the middle of the gauge body 1 base, and expanding several millimeters in diameter by the time it reaches the gauge body 1 head.

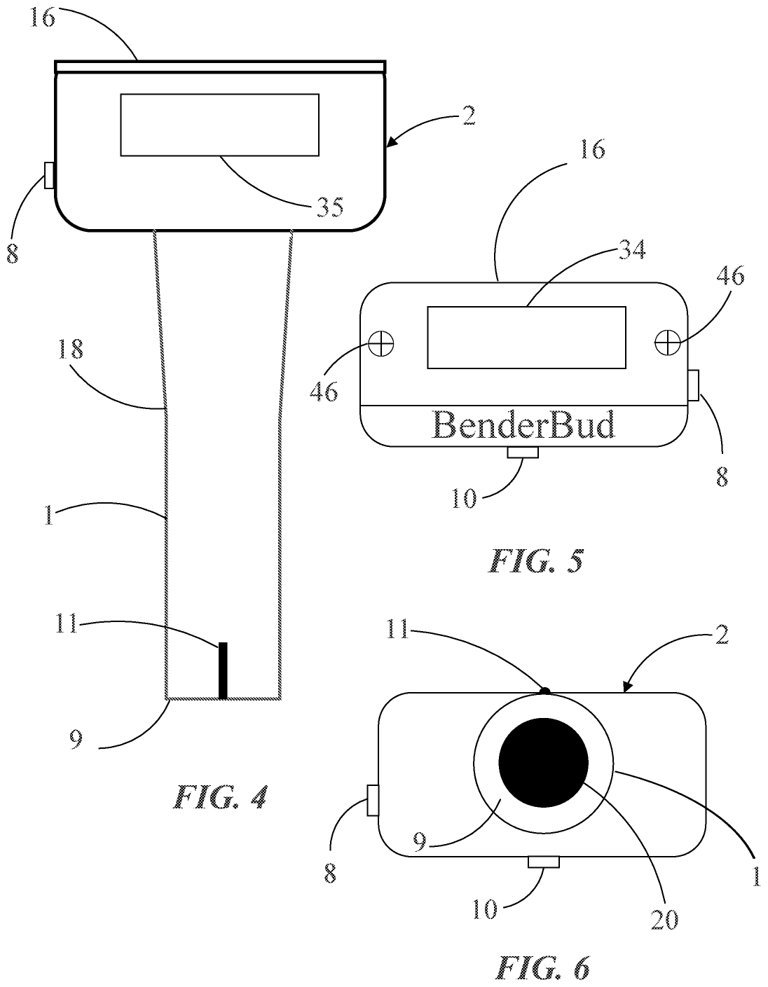

FIG. 4 is a rear-view of the device 2 showing the power switch 8 in profile on the left. The inverted OLED display 35 is centered in the body of the device 2 and the protractor indicator pointer 11 is seen at the bottom center. The inverted display 35 is only activated during conduit bending to provide a continuous viewing experience when bending conduit beyond 30 degrees, and inverted leveling when the device 2 is suspended from above by magnetic or mechanical means.

FIG. 5 shows the top faceplate 16 of the device 2 attached with two M3X.5 screws 46 and the OLED display 34 in the center. The five-position function switch 10 and the power switch 8 may be seen in profile.

FIG. 6 shows a bottom view of the device 2 including the protractor indicator pointer 11, the power switch 8 and the function switch 10 in profile. The N-52 Neodymium magnet 20 may be seen centered in the base of the gauge body 1.

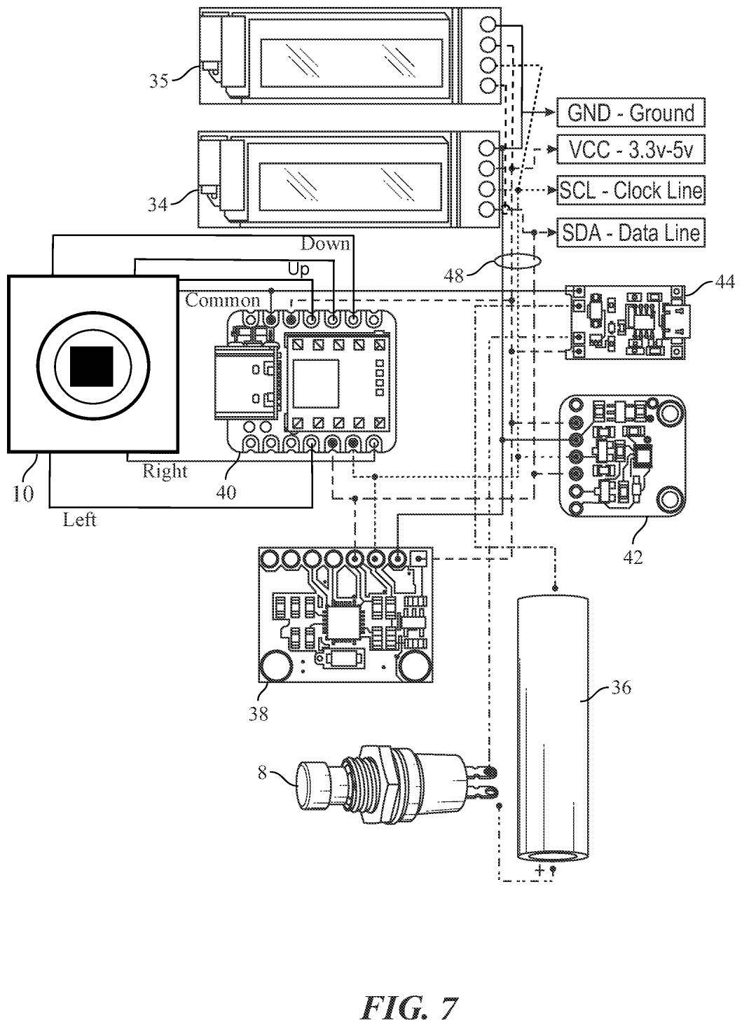

FIG. 7 is a wiring pictorial showing how the 4-conductor harness 48 connects the two OLED displays 34 and 35, MPU60050 38, Seeeduino XIAO 40, and the BME280 42 using I2C communications protocol. Also shown is the connection for the 18650 battery 36 to the TP4056 USB battery charging module 44 and power switch 8. The five-position function switch 10 is shown grounding digital pins (dp3, dp6, dp8, dp9, and/or dp10) of the XIAO 40 to various digital control signals when momentarily closed.

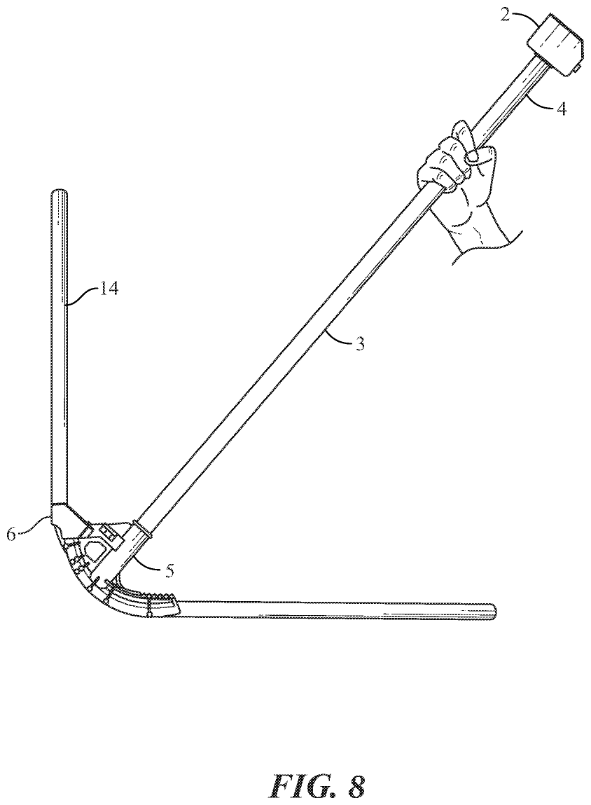

FIG. 8 shows a profile view of a typical conduit bender 3 with the device 2 seated in the handle 4 engaging a piece of conduit 14 that has been bent into a 90-degree angle. The hook 6 of the conduit bender 3 grasps the conduit 14 and holds it firmly against the former 5 of the conduit-bender 3 while being smoothly bent.

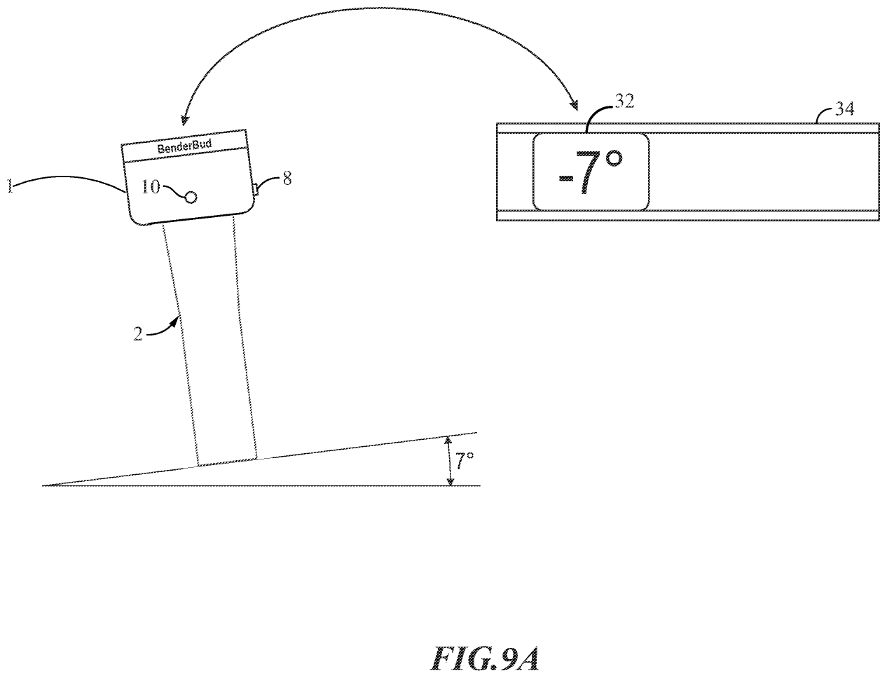

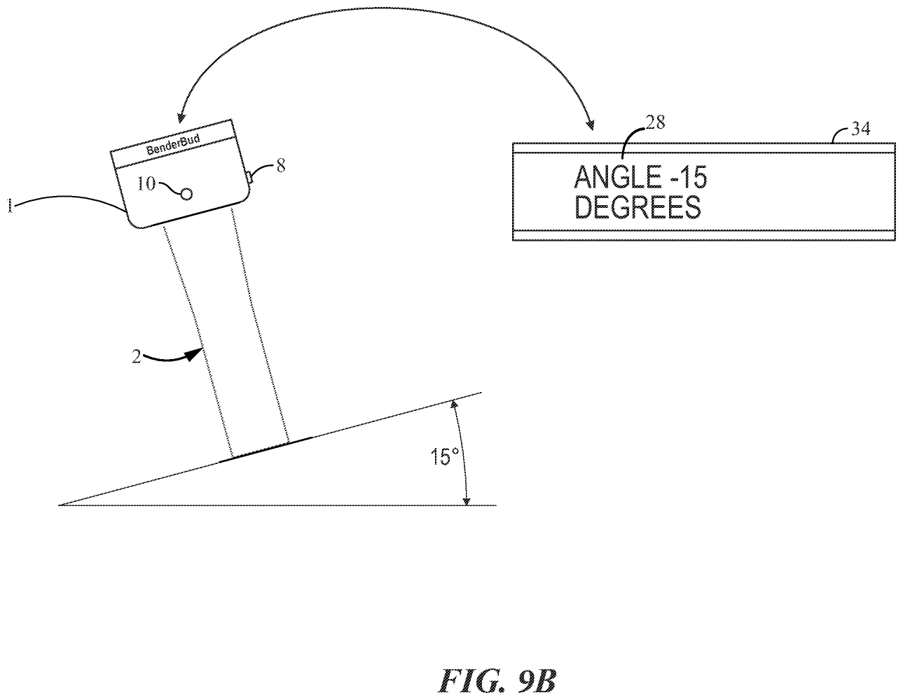

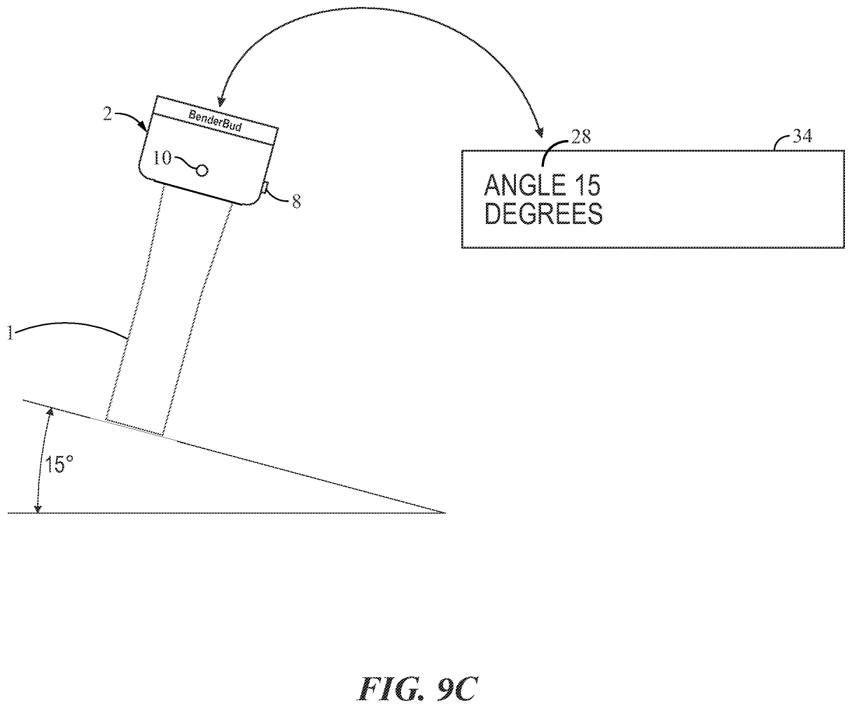

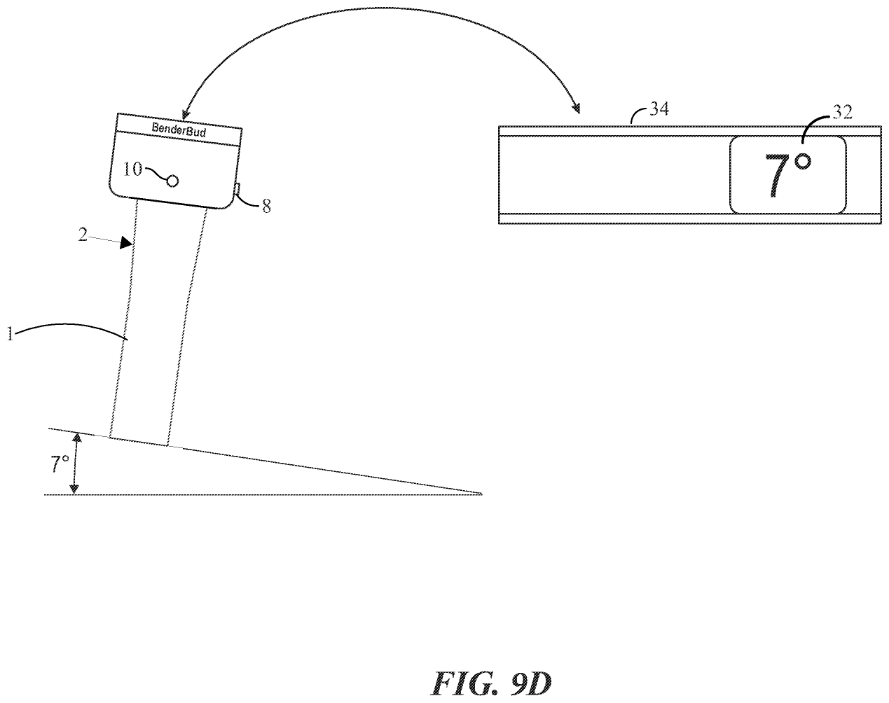

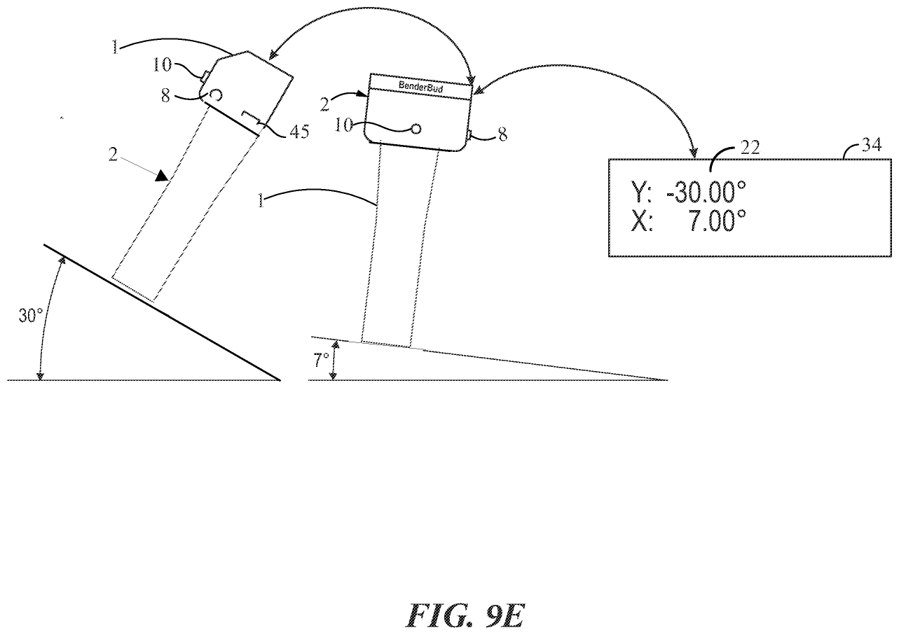

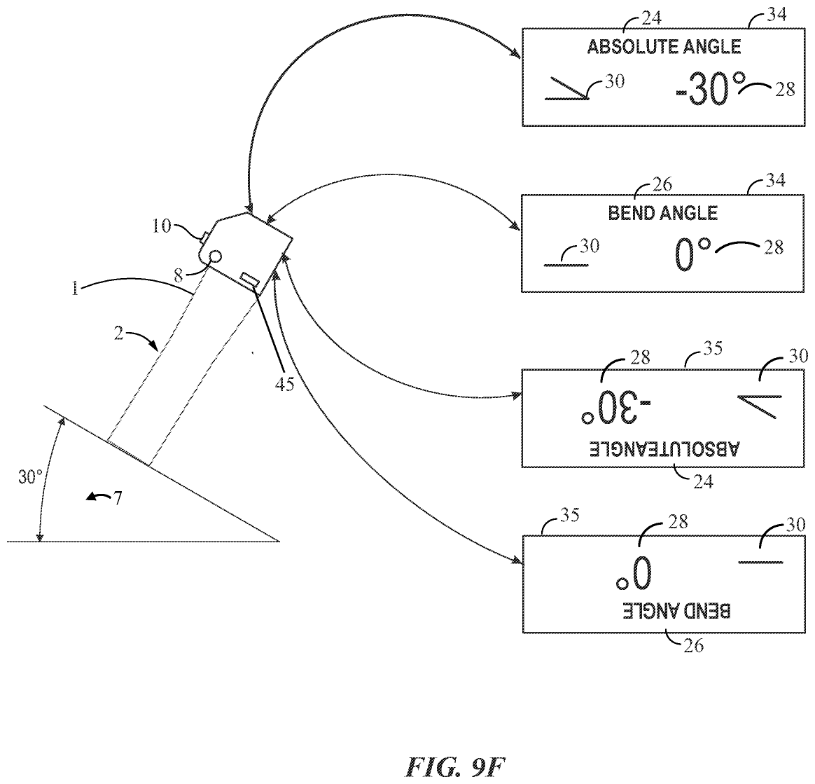

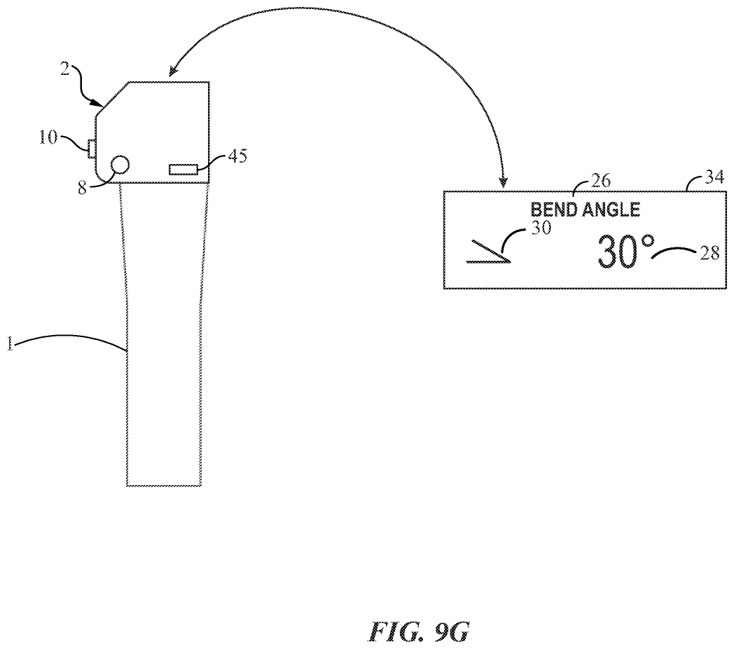

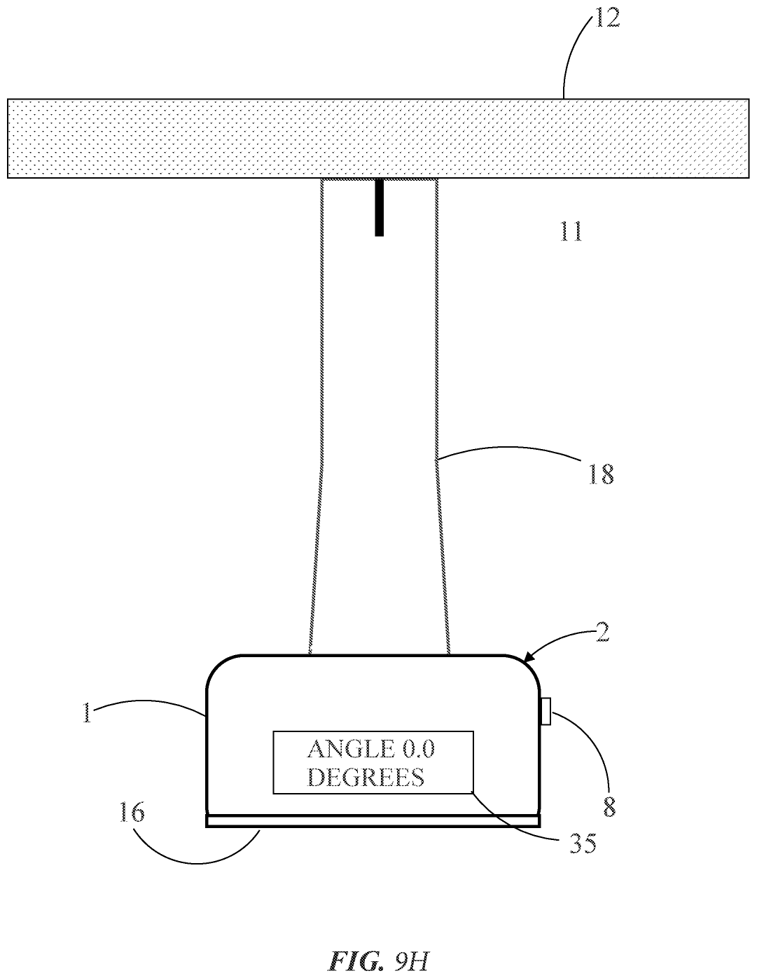

FIG. 9A shows the device 2 on a negative 7-degree incline along the X-axis relative to the operator. The power switch 8 is seen in profile while the five-position function switch 10 is seen face-on. The readout of the OLED display 34 is shown as a bubble with a number inside of it that has moved towards the left side of the screen.

FIG. 9B shows the device 2 on a negative 15-degree incline along the X-axis relative to the operator. The power switch 8 is seen in profile while the five-position function switch 10 is seen face-on. The readout of the OLED display 34 is shown as text that indicates the exact negative angle.

FIG. 9C shows the device 2 on a positive 15-degree incline along the X-axis relative to the operator. The power switch 8 is seen in profile while the five-position function switch 10 is seen face-on. The readout of the OLED display 34 is shown as text that indicates the exact positive angle.

FIG. 9D shows the device 2 on a positive 7-degree incline along the X-axis relative to the operator. The power switch 8 is seen in profile while the five-position function switch 10 is seen face-on. The readout of the OLED display 34 is shown as a bubble with a number inside of it that has moved towards the right side of the screen.

FIG. 9E depicts the device 2 being used as a 4-Way Level, measuring two angles simultaneously. The face-on view shows the device 2 on a positive 7-degree angle along the x-axis relative to the operator and the right-side view shows the device 2 on a negative 30-degree angle along the Y-axis relative to the operator. These two angles are depicted on the OLED screen 34 as a Dual Axes angular display. Briefly pressing the five-position Function Switch 10 sets this angle to zero along both axes. A long press stores the angles as needed. The Power Switch 8 and the USB port of the TP4056 Battery Charger 44 are clearly depicted on this drawing, as well.

FIG. 9F shows the device 2 being used as a conduit bending angle indicator. When this function is engaged, the inverted OLED display 35 activates for ease of viewing across the entire conduit bend. When the former 5 of a typical conduit bender 3 engages a piece of conduit 14 with its hook 6, the OLED displays 34, 35 will show an absolute angle 24 of negative thirty degrees, as the device 2 is facing away from the operator. Upon pressing the five-position Function Switch 10, the device zeros out and displays a relative angle 26 of zero degrees, essentially subtracting the absolute angle from itself. As the conduit bender 3 is rolled towards the operator, the OLED displays 34, 35 display the absolute angle of the conduit, not the conduit bender. Also shown in this drawing is the Power Switch 8 and the USB port for the TP4056 Battery Charging Module 44. The device 2 includes a gauge body 1 having a reference surface 9 (for use as a level or protractor) and a tapered cylindrical reference surface 18 (for proper alignment with any standard-sized conduit bender handle 4).

FIG. 9G shows the device 2 being used as a conduit bending angle indicator that has been rolled back towards the operator, so the device 2 is vertical, but the bend angle of the conduit is 30-degrees because the device zeroed itself out at negative 30-degrees when the bend of FIG. 9F began.

FIG. 9H shows the device 2 suspended by its Neodymium magnet 20 to an overhead beam 12. When the device is inverted, or rotated greater than 90 degrees from vertical, the inverted OLED display 35 activates for ease of viewing.

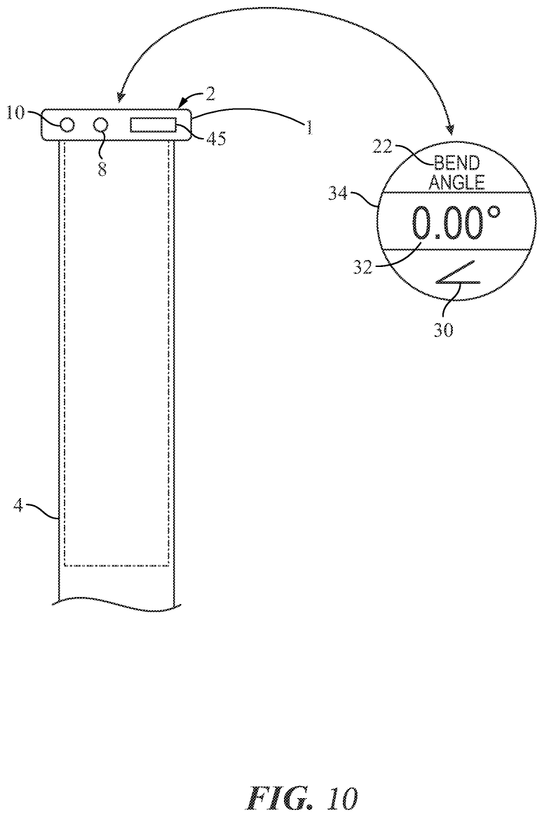

FIG. 10 depicts the device 2 designed to fit entirely inside of the handle 4 of a typical conduit bender 3, either built into the bending device during manufacturing or sold as a compact retrofit. This drawing clearly shows the five-position Function Switch 10, the Power Switch 8, the USB port of the TP4056 Battery Charging Module 45 as well as the OLED display 34. The text 22 indicates that we are in the Bend (Relative) mode, the 3-Digit Angle Indicator 28 shows a positive angle of 30-degrees, and the graphic 30 is in visual agreement with this number. This drawing depicts the same situation as FIG. 9G, a device reading a positive bend angle of 30-degrees in a vertical position after having been used for a conduit bend.

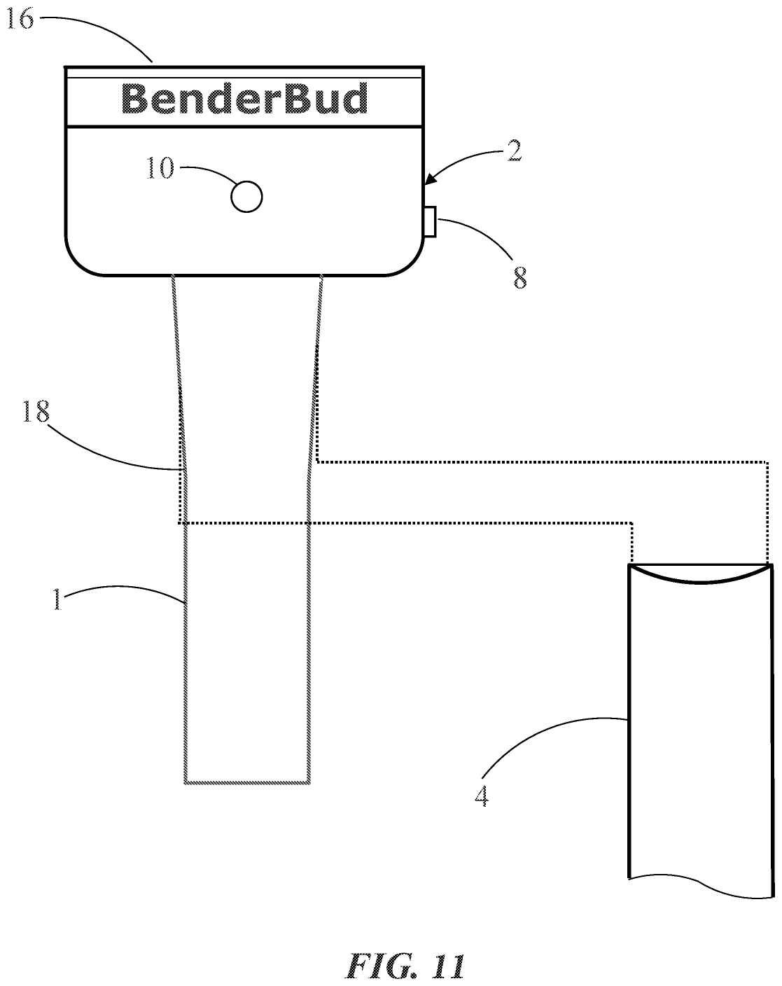

FIG. 11 shows the device 2 with Power Switch 8 and five-position Function Switch 10 being inserted into the handle 4 of a typical conduit bender 3 until it is retained by friction introduced by the tapered base reference surface 18. This allows the device 2 to fit snuggly into any size conduit bender 3.

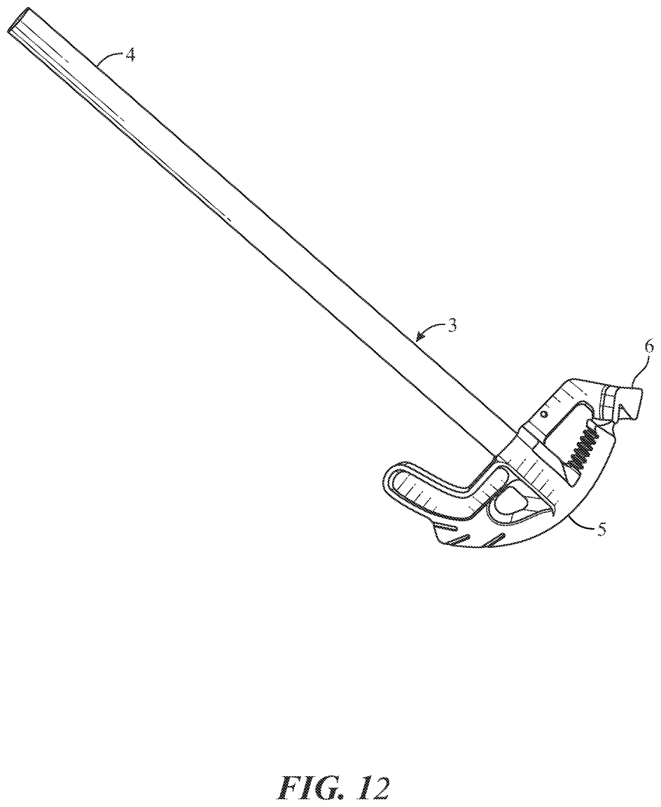

FIG. 12 depicts a typical conduit bender 3 showing the handle 4, former 5, and hook 6 without engaging conduit 14. The device inserts into the open handle 4 of the conduit bender 3 facing the upper left and is aligned with the conduit bender's plane of motion.

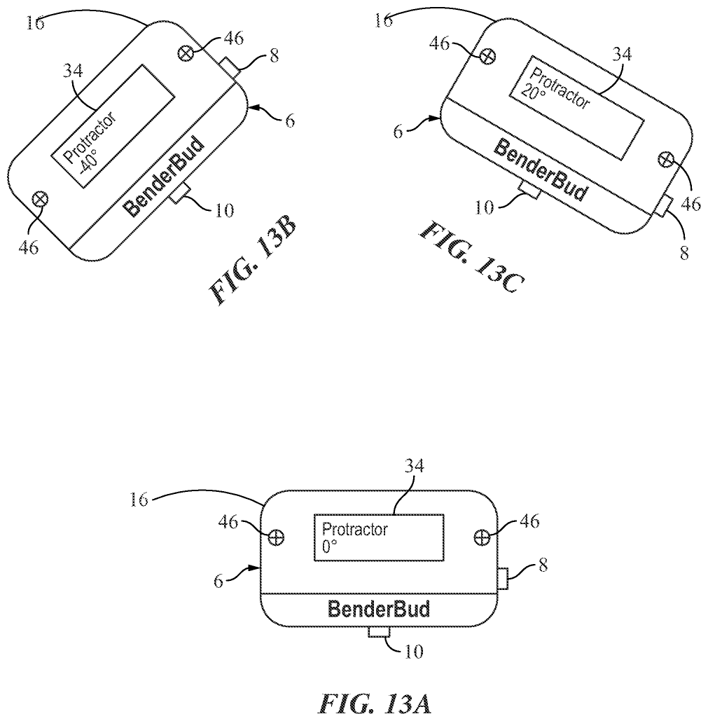

FIG. 13A shows the face of the device 2 displaying the Protractor Feature reset to zero degrees, relative to the operator.

FIG. 13B shows a rotation of negative 40 degrees.

FIG. 13C shows a rotation of positive 20 degrees.

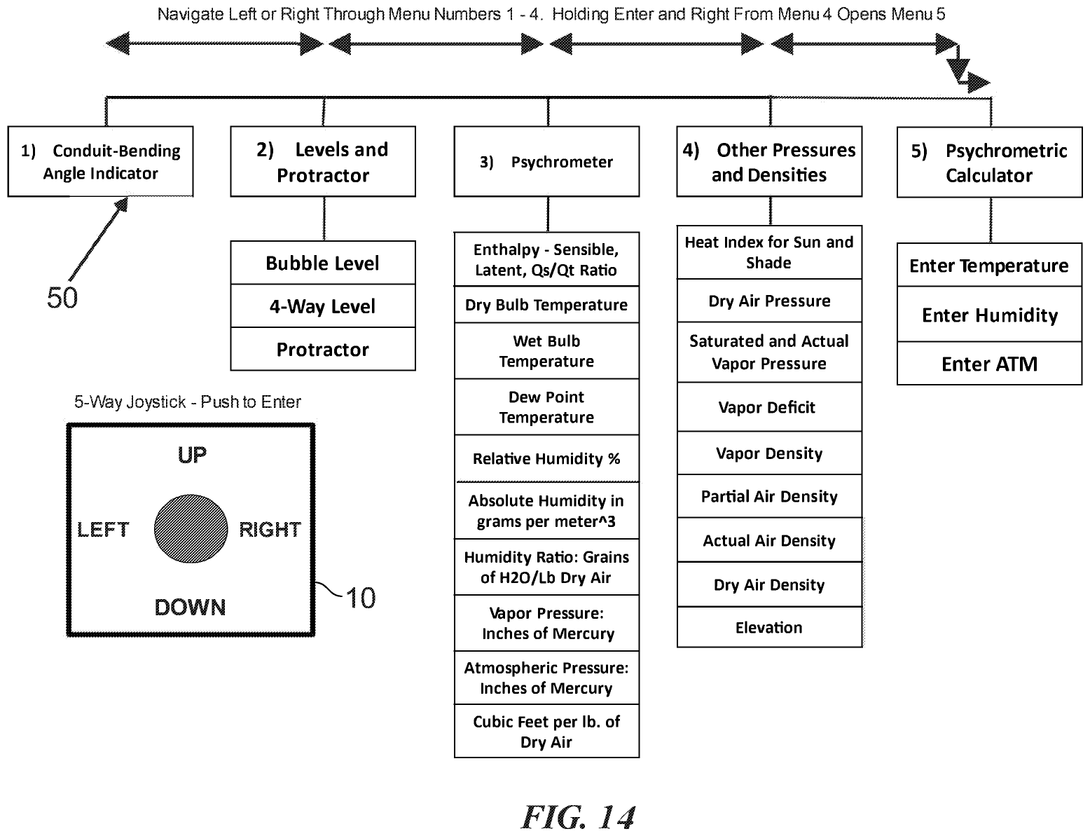

FIG. 14 illustrates a block diagram of the navigation menu 50 displaying the following main menus: a conduit-bending angle indicator; levels and protractor; psychrometric data; pressures and densities; and psychrometric calculator. The operating system is accessed by the five-position function switch 10 which allows the operator to navigate the user interface and select menus, functions, and data input. The five-position function switch 10 is a micro-joystick with an up/down/left/right/push entry scheme for a total of five switches in one. This improves the navigation of the device, allowing for one-handed navigation. Left and right presses select menus while up and down presses select menu items. A direct press enters or selects the displayed parameter,

The Electronic Conduit Bending Indicator, Level, and Environmental Data Display 2 (hereafter referred to as “device” or “the device”) is an electronic Swiss Army Knife for many construction trades. Its principal function is that of an electronic conduit-bending indicator. By inserting the tapered battery compartment into the open handle 4 of an ordinary conduit bender 3, device 2 enables the operator to display the exact bend angle imparted to any piece of conduit, metal tubing, or solid metal rod that may be bent by hand. The dual displays afford easy viewing at any angle allowing precise, repeatable bends for conduit runs that must have a professional appearance.

When removed from a conduit bender 3, device 2 is a free-standing device with a magnetic base. It will vigorously adhere to any ferrous metal and may be attached to a metal plate when used for finding angular differences of non-ferrous items or simply held in place while capturing the data for future display. In this freestanding mode, the device 2 has a Bubble Level that operates on the X-Axis. A digital “bubble” 32 is displayed surrounding angles between negative and positive nine with text being the default for numbers greater than nine and less than negative nine.

When reading construction plans or determining approximate angular differences, the Protractor function is easy to use. Simply press the five-position function switch 10 to reset the protractor to zero and rotate the device to the left or right to read.

When one needs more than one angular measurement simultaneously, the 4-Way Level is a perfect solution. It displays in both the X-axis and Y-axis relative to the operator with a tenth of a degree accuracy. The 4-Way Level also operates in both absolute and relative modes. A brief press of the five-position function switch 10 resets the current angle to zero degrees for both axes while a longer press holds the data for later display.

For safety and OSHA compliance, the Heat Index display shows the way the temperature feels to a human body in both sunny and shady conditions. The Heat Index is used to determine the work/break cycle for many corporations, unions, and trades. In extreme conditions, one might work for 20 minutes every hour with forty minutes of break time to avoid heat-stroke.

Finally, there is an electronic psychrometric chart and “Other Pressures and Densities” page. These menus have an exhaustive list of features including dry-bulb, wet-bulb, and dew-point temperature, OSHA heat-index, enthalpy (sensible and latent), saturated and actual vapor pressure, relative humidity, absolute humidity, humidity ratio, vapor pressure, cubic feet per pound of dry air, atmospheric pressure, altitude, vapor deficit, vapor density, and partial, actual, and dry air densities. The device 2 displays, by default, temperatures in Fahrenheit. For Celsius, hold the function switch 10 when the logo appears on the display 34 upon power-up until the main menu appears.

The device 2 is comprised of a suitable body in which to house the necessary electronic components. The preferred iteration is 3D-printed PETG but the means, methods, and materials to create a housing are virtually unlimited.

All components are typical, off-the-shelf, parts that may purchase from Amazon, eBay, Mousser Electronics, DigiKey Electronics, etc. The displays 34 and 35 are OLED, I2C, 32×128 devices manufactured by numerous companies. Power is provided by a standard 18650 LiPo battery 36 that is permanently sealed in the base of the unit in line with, and above, the magnet 20.

The device 2 is recharged through the micro-USB port 45 on the TP4056 battery charging module 44 and is energized by the power switch 8 located above, and it front of, the micro-USB port 45 of the battery charging module 44 on the right side of the device. See FIG. 2 for more details. The BME280 atmospheric module 42 is mounted on the inner left of the device and has a port 15 to allow exposure to air. See FIG. 3 for more details. The MPU6050 38 angular sensor is mounted horizontally on a molded shelf inside of the 3D-printed shell and the XIAO microprocessor 40 is free floating inside of the body of the device, nestled within the connection harness 48.

In some embodiments, The MPU6050 may be directly replaced with an MPU9250 which also contains a compass feature. This may be useful as a directional-finding compass (again, built into an appropriate housing) for out-of-door activities, or for proper orientation on a surface over time. To elaborate, the built-in protractor is a relative feature based on any previously defined angular parameter. The compass feature allows reference to actual F/W/N/S compass headings to allow repeatable angular measurements, regardless of location or reference.

All major components are connected with only four color-coded wires: (Vdc: red, Ground: black, Data: green, and Clock: yellow) that comprise the connection harness 48. The five-position function switch 10 connects one of five digital pins (dp3, dp6, dp8, dp9, or dp10) of the XIAO 40 to ground when closed, Construction techniques are simple and straightforward by 3D-printing the body and hand-wiring the modules to the harness by hand-soldering.

All software was written and compiled on an Arduino IDE using commonly available libraries and simple C++ routines to create the operating system for the device 2 that is represented by the Navigation Menu 50. The final computer code is proprietary information but can easily be written by someone knowledgeable in the trade. While the features and functions described above represent the current embodiment, they are not meant to limit or restrict the scope of this invention, and future improvements may be incorporated without straying from the original intent.

Following are the download sites and sources of code for the libraries associated with the components used in creating the device.

MPU6050 Library: https://www.arduino.cc/reference/en/ibraries/mpu6050

BME280 Library: https://www.arduino.cc/reference/en/libraries/bme280/

OLED Display Library: https://learn.adafruit.com/mnochrome-oled breakouts/arduino-library-and-examples

Seeeduino XIAO Arduino Library: https://wiki.sceedstudio.com/Seeduino-XIAO/

TP4056 Data Sheet: http://www.tp4056.com/datasheet/

18650 LiPo Battery Data Sheet: https://somanytech.com/18650-battery-specifications-datasheet-18650-battery-specs/

The following are the mathematical formulas used in the Calculations to provide psychrometric data:

Dew Point is calculated with the following variation of the Magnus formula:

$$Td = 243.12 * \frac{ln ( RH / 100. ) + ( \frac{17.625 * Tc}{243.12 + Tc} )}{( ( 17.625 - ln ( \frac{RH}{100.} ) ) - ( \frac{17.625 * Tc}{243.12 + Tc} )}$$

Saturated Vapor Pressure is derived from the following equation:

VP=6.1078*10((7.5*Tc)/(Tc+237.3))

And Actual Vapor Pressure=(VP*RH/100)

Vapor Pressure Deficit=Saturated Vapor Pressure−Actual Vapor Pressure

Specific Humidity=0.622017*Vapor Pressure/(Air Pressure−Vapor Pressure)

Absolute Humidity=(6.112*AbHu*Humid*2.1674)/(273.15+° C.)

[AbHu={pow(2.718281828,(17.67*° C.)/(° C.+243.5)}]

Humidity Ratio=0.62198*(Vapor Density/Dry Air Density)

Dry Air Density=(Air Pressure in Pascals)/(287.058*(° C.+273.15))

Vapor Density=(Vapor Pressure in Pascals)/(461.495*(° C.+273.15))

Partial Air Pressure=Atmospheric Pressure−Vapor Pressure

Partial Air Density=(Dry Air Pressure in Pascals)/(287.058*(° C.+273.15))

Actual Air Density=Partial Air Density+Vapor Density

Enthalpy=((1.006*)+(0.0106*(2501+1.805*° C.))*0.4299

Sensible Heat=Dry Bulb Temperature (° F.)*0.24

Latent Heat:=Enthalpy−Sensible Heat

Sensible Heat Ratio=Sensible Heat/Enthalpy

Wet Bulb is attained from the following formula:

Tw=Tc*atan(0.151977*sqrt(RH+8.313659))+atan(Tc+RH)−atan(RH−1.6763)+(0.00391838*pow(Humid)\hat{ }/2*atan(0.0231*Humid))−4.686

Heat Index (shady) is calculated with the following National Weather Service formula:

HI=−42.379+(2.04901523*Tf+10,14333127*RH−0.22475541*Tf*RH)−(0.00683783*Tf*Tf)−(0.05481717*RH*RH+(0.00122874*Tf*Tf*RH)+(0.00085282*Tf*RH*RH)−(0.00000199*Tf*Tf*RH*RH)

Where RH=relative humidity and Tf=temperature in Fahrenheit. Heat Index (Sunny) is derived by adding 15° to Tf before calculating.

In some embodiments, the device 2 may be in wireless communication (via wireless Internet, near-frequency communications, and the like) with a network and associated devices (e.g., smart devices, tablets, PDA's, laptop computers, desktop computers, etc.) in communication with the network. The wireless connectivity allows for measuring an angle in which line-of-site to the display is impeded. The device 2 having wireless connectivity may also be utilized by a foreman, instructor, or other supervisory personnel to monitor conduit bends executed by others. This may allow multiple devices to be connected wirelessly and monitored. Conduit bends and psychrometric data may be uploaded as scores to a grading portal or competitive learning portal to make a game out of successful bends or psychrometric calculations.

In some embodiments, the wirelessly connected device 2 transmit psychrometric data. The device 2 may be continuously powered by means of the USB charging port allowing the device to be located remotely inside of refrigerated rooms, HVAC ducting, or room-to-room monitoring using multiple devices connected in a mesh network. In this scenario, the device 2 may be packaged in a more suitable weather-proof housing with a smaller backup battery while maintaining the magnet for attachment to ferrous metallic surfaces.

In some embodiments, the device 2 may be supplied with an inductive charging port. This would allow the device 2 to be more easily powered in remote locations or when USB charging is not practical.

In some embodiments, the device 2 includes a Wait Meter, showing the solar irradiation in watts per meter squared. The Watt Meter may be readily added with a photovoltaic cell. When sunlight illuminates the photocell, the microprocessor measures the current generated and converts the analog measurement into a readable value of the intensity of the sunlight. This is useful for verifying the output of a photovoltaic system on other than clear and sunny days. The photocell can further be used to turn the device on or off during periods of light or darkness, as desired.

In some embodiments, the device 2 includes a motion detector which mar be useful in remote locations when data is desired to be collected when the area is occupied or there is motion. This may be psychrometric data that is collected when motion is detected with an outdoor camera, or when someone enters a room.

In some embodiments, the device 2 includes a micro-camera sensor. This would allow a remotely placed device 2 to record visual data along with psychrometric data in a remote location. This could be for the purposes of animal identification as a psychometrically enhanced trail-camera or as an identity-detector/security camera in a refrigerated or controlled-climate room. The resulting information could be assembled into a complete file representing an image, time-stamp, and all psychrometric conditions at the moment.

In some embodiments, the device 2 may include one or more gas sensors to detect carbon monoxide, carbon dioxide, sulfur dioxide, methane, butane, or other dangerous or flammable gasses. This would allow the device 2 to act as a remote sensor in a mine, tunnel, or other enclosed area and transmit environmental gas information along with psychrometric data.

In the current embodiment, the device 2 has capabilities similar to a calculator to enhance data-entry capabilities of psychrometric values. Having a five-position function switch 10 allows the place of the number being entered to be selected (ones, tens, hundreds, etc.) using the left and right switches, as well as the numeric value of the digit in that place by using the up/down button. When the entire numeric value has been selected, one simply pushes the function switch to “enter” the data into memory. The psychrometric calculator allows input of the three most commonly available atmospheric readings: temperature, relative humidity, and atmospheric pressure. All other functions are derived from these initial three measurements, either from the psychrometric calculator or the BME280.

Many different embodiments have been disclosed herein, in connection with the above description and the drawings. It will be understood that it would be unduly repetitious and obfuscating to literally describe and illustrate every combination and sub-combination of these embodiments. Accordingly, all embodiments can be combined in any way and/or combination, and the present specification, including the drawings, shall be construed to constitute a complete written description of all combinations and sub-combinations of the embodiments described herein, and of the manner and process of making and using them, and shall support claims to any such combination or sub-combination

It will be appreciated by persons skilled in the art that the present embodiment is not limited to what has been particularly shown and described hereinabove A variety of modifications and variations are possible considering the above teachings without departing from the following claims.

What is claimed is:

1. A digital angle gauge, comprising:
a gauge body with a partially tapered base that is insertable into the open top end of the handle of a standard conduit bender of the type generally having an upwardly projecting tubular said handle and having a lower threaded end for inserting onto and affixing a head to said handle, an elongated bottom shoe portion integrally fabricated into said head and defining a downwardly opening groove which is convexly arcuate along its length and is concavely arcuate laterally, with a conduit grasping means at the end of said shoe for hooking around a conduit which is received in said groove with embossed angle indicators aligned along the exterior wall of said groove; digital display means mounted on said gauge body face for visually determining the bend angle of a piece of said conduit engaged by said conduit bender, such that the interior of the open conduit bender handle end becomes the reference surface for conduit bending;
the gauge body including a reference surface that is engageable with the surface of an object to be measured for inclination;
means mounted in the gauge body for determining an inclination angle of the surface of an object with which the reference surface of the gauge body is engaged;
at least two digital screens connected to the top and rear of the gauge body responsive to the means for calculating and visually displaying the determined inclination angle;
means mounted in the gauge body for determining the temperature, relative humidity, and atmospheric pressure to generate psychrometric data; and
a five-position function switch to permit a user to navigate an operating system.

2. The device of claim 1, further comprising a means for wirelessly communicating with a network to permit the wireless reception of data received from the device.

3. The device of claim 1, wherein the two digital screens are simultaneously or alternately energized based on the angle of the device for continuous viewing.

4. The device of claim 1, wherein the at least one manually engageable power switch operates as an ON/OFF button that is selectively engaged to alternately activate and deactivate the sensors, microprocessor, and the digital screens.

5. The device of claim 1, wherein the five-position function switch includes a ZERO angle calibration function that is momentarily engaged to set an incremental ZERO angle reference point, the inclination angle comprising an incremental inclination angle determined relative to the ZERO angle reference point.

6. The device of claim 1, wherein the inclination angle comprises an absolute inclination angle determined relative to an absolute zero point stored in the device.

7. The device of claim 1, wherein the screens include a first section for numerically displaying the absolute inclination angle and a second section for numerically displaying the incremental inclination angle.

8. The device of claim 1, wherein the first and second screen sections display the absolute and incremental inclination angles simultaneously and adjacent to one another on the screen.

9. The device of claim 1, wherein the screen sections display respective numerical characters, the characters in one of the screen sections being larger than the characters in the other the screen section.

10. The device of claim 1, wherein the screens include a graphic display that intuitively and non-numerically depicts the absolute inclination angle adjacent to the numerical display of the absolute inclination angle on the screen.

11. The device of claim 1, wherein the graphic display simulates a bubble level vial and includes a bubble icon moveable on the simulated bubble level vial between positions that correspond to respective ranges of absolute inclination angle measurements.

12. The device of claim 1, wherein the five-position function switch includes a “HOLD” function for visually locking the display of a determined inclination angle on the screen.

13. The device of claim 1, wherein the bottom face carries a magnet for securing the body to a magnetically attractive material in the object being measured.

14. The device of claim 1 wherein the bottom rear exterior has a vertical indicating means for visually determining angular differences when used as a protractor.

15. The device of claim 1 in which the operating system and software are incorporated into a conduit bending tool, such that it becomes an off-the-shelf “electronic” conduit bender.

16. The device of claim 1 in which the psychrometric data generated includes, but is not limited to enthalpy, wet-bulb and dew-point temperatures, absolute humidity, humidity ratio, vapor pressure, heat index, dry air pressure, saturated and actual vapor pressure, vapor deficit, vapor density, partial, actual, and dry air density, and elevation.

17. The device of claim 1 in which the necessary basic parameters of temperature, relative humidity, and atmospheric pressure may be manually entered in a psychrometric calculator, over-riding the atmospheric sensor data.
